(19) United States
(12) Patent Application Publication
(10) Pub. No.: US 2009/0052197 A1
(43) Pub. Date: Feb. 26, 2009

(54) REAR LIGHT FOR A MOTOR VEHICLE

(75) Inventors: Oliver Peters, Wiernsheim (DE); Heinz Redlich, Vaihingen-Enz (DE)

Correspondence Address: LERNER GREENBERG STEMER LLP, P O BOX 2480, HOLLYWOOD, FL, 33022-2480, US

(73) Assignee: Dr. Ing. h.c. F. Porsche Aktiengesellschaft, Weissach (DE)

(21) Appl. No.: 12/195,824

(22) Filed: Aug. 21, 2008

(30) Foreign Application Priority Data
Aug. 24, 2007 (DE) 102007040105.3

(51) Int. Cl. B60Q 1/44

(52) U.S. Cl. 362/487; 340/479

(57) ABSTRACT

A rear light for a motor vehicle has a light chamber for holding at least one lighting device for a flashing light and further has at least one light chamber which adjoins the light chamber for the flashing light and has the purpose of holding at least one lighting device for a reversing light, for holding at least one lighting device for a tail light, for holding at least one lighting device for a brake light and/or for holding at least one lighting device for a fog light. Wherein a plurality of LEDs are positioned in the light chamber for the flashing light and transmit light toward the rear for the flashing light. Accordingly, the rear light contains at least one LED which transmits light for the flashing light into a light chamber which is positioned adjacent to the light chamber for the flashing light.

### CROSS-REFERENCE TO RELATED APPLICATION

This application claims the priority, under 35 U.S.C. §119, of German application DE 10 2007 040 105.3, filed Aug. 24, 2007; the prior application is herewith incorporated by reference in its entirety.

### BACKGROUND OF THE INVENTION

1. Field of the Invention

The invention relates to a rear light for a motor vehicle. The rear light contains a first light chamber and at least one lighting device for projecting a flashing light. The lighting device has a plurality of LEDs positioned in the first light chamber and transmits light toward a rear for forming the flashing light. At least one further lighting device is provided and is a reversing light, a tail light, a brake light, or a fog light. At least one second light chamber adjoins the first light chamber and holds the further lighting device.

Rear lights for a vehicle usually have a plurality of light chambers, specifically one light chamber for holding at least one lighting device for a flashing light, one light chamber for holding at least one lighting device for a reversing light and one light chamber for holding at least one lighting device for a tail light and/or at least one lighting device for a brake light and/or at least one lighting device for a fog light. The individual light chambers for the different light functions or types of light of the rear light are typically separated from one another by webs or walls.

LEDs are being increasingly used as a lighting device in rear lights for a vehicle. For example, it is already the state of the art to position a plurality of LEDs in the corresponding light chamber of the rear light as a lighting device for the flashing light, wherein the LEDs transmit the light for the flashing light toward the rear. In particular if the light chamber for the flashing light is separated from adjoining light chambers by webs or walls, it is, under certain circumstances, not possible to perceive the flashing light even when there is an oblique viewing angle onto the rear light. However, legislators prescribe that it must be possible to perceive the flashing light even if the viewing angle onto the rear light is 45°. There is therefore a need for a rear light for a motor vehicle in which the flashing light can be perceived with certainty and reliably even when this condition applies.

### SUMMARY OF THE INVENTION

It is accordingly an object of the invention to provide a rear light for a motor vehicle that overcomes the above-mentioned disadvantages of the prior art devices of this general type, which has improved visibility of its flashing light.

With the foregoing and other objects in view there is provided, in accordance with the invention, a rear light for a motor vehicle. The rear light contains a first light chamber and at least one lighting device for projecting a flashing light. The at least one lighting device includes a plurality of LEDs positioned in the first light chamber and transmit light toward a rear for forming the flashing light. At least one further lighting device is provided and is a reversing light, a tail light, a brake light, and/or a fog light. At least one second light chamber adjoins the first light chamber and holds the at least one further lighting device. At least one of the LEDs transmitting light for forming the flashing light projects into the second light chamber positioned adjacent to the first light chamber.

The problem is solved by the rear light according to the invention. The rear light accordingly to the invention contains at least one LED which transmits light for the flashing light into a light chamber which is positioned adjacent to the light chamber for the flashing light.

In the sense of the present invention here, the rear light contains at least one LED which transmits light for the flashing light into a light chamber which is positioned adjacent to the light chamber for the flashing light. As a result it is possible to ensure that the flashing light can be perceived with certainty and reliably even when there is a viewing angle of 450 onto the rear light. The light chamber which is positioned adjacent to the light chamber for the flashing light and into which at least one LED transmits light for the flashing light is preferably positioned to the side of the light chamber for the flashing light when viewed in the horizontal direction, specifically is positioned closer to the center of the vehicle than the light chamber for the flashing light. As a result the flashing light can also be perceived with certainty even if the viewing angle onto the rear light is 45° from the inside.

At least one LED preferably transmits light for the flashing light into the light chamber for the reversing light which is positioned adjacent to the light chamber for the flashing light. The transmission direction of the, or of each, LED which transmits light for the flashing light into the light chamber for the reversing light is preferably offset by an angle of approximately 90° with respect to the transmission direction of the other LED for the flashing light.

In accordance with an additional feature of the invention, the further lighting device is a reversing light disposed in the second light chamber, and the one LED transmits light for the flashing light into the second light chamber for the reversing light which is positioned adjacent to the first light chamber for the flashing light.

In accordance with a further feature of the invention, the second light chamber for the reversing light is positioned to a side of the first light chamber for the flashing light. More specifically, the second light chamber for the reversing light is positioned further inward with respect to a center of a vehicle when compared to the first light chamber for the flashing light.

In accordance with an added feature of the invention, a transmission direction of the one LED which transmits light for the flashing light into the second light chamber which is adjacent to the first light chamber, is offset by an angle between 30° and 150° with respect to a transmission direction of other ones of the LEDs forming the flashing light.

In accordance with a further feature of the invention, a transmission direction of the one LED transmitting light for the flashing light into the second light chamber which is adjacent to the first light chamber is offset by an angle between 45° and 135° with respect to a transmission direction of other ones of the LEDs for the flashing light.

In accordance with another added feature of the invention, a transmission direction of the one LED transmitting light for the flashing light into the second light chamber which is adjacent to the first light chamber is offset by an angle between 60° and 120° with respect to a transmission direction of other ones of the LEDs for the flashing light.

Other features which are considered as characteristic for the invention are set forth in the appended claims.

Although the invention is illustrated and described herein as embodied in a rear light for a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, illustration of a rear light according to the invention; and

FIG. 2 is a diagrammatic, cross-sectional view through the rear light shown in FIG. 1.

### DETAILED DESCRIPTION OF THE INVENTION

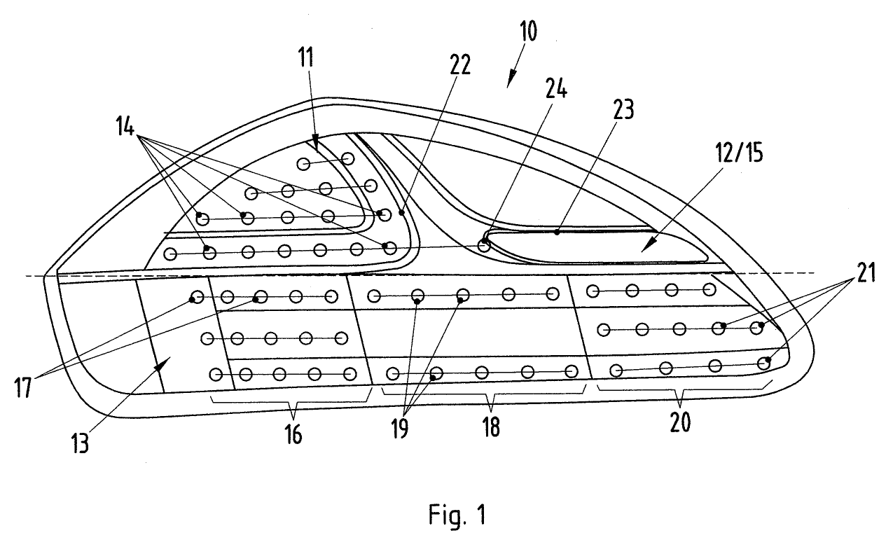

Referring now to the figures of the drawing in detail and first, particularly, to FIG. 1 thereof, there is shown a schematic illustration of an inventive rear light 10 for a motor vehicle. The rear light 10 has a plurality of light chambers in each of which at least one lighting device is positioned.

The rear light 10 in FIG. 1 therefore has a light chamber 11 for a flashing light, a light chamber 12 for a reversing light and a light chamber 13 for a fog light, a tail light and a brake light. A plurality of LEDs 14 are positioned in the light chamber 11 for the flashing light as a lighting device for the flashing light.

A lighting device 15 for the reversing light is positioned in the light chamber 12 for the reversing light. A plurality of LEDs, specifically LEDs 17 which are assigned to a lighting region 16 for the fog light, LEDs 19 which are assigned to a lighting region 18 for the tail light and LEDs 21 which are assigned to a lighting region 20 for the brake light are in turn positioned in the light chamber 13.

According to FIG. 1, the light chamber 11 for the flashing light is separated from the light chamber 12 for the reversing light and from the light chamber 13 for the fog light, the tail light and the brake light by a web or a wall 22. The light chamber 12 for the reversing light is likewise surrounded by a wall 23 which separates the light chamber 12 for the reversing light from the respectively adjacent light chambers 11, 13.

The rear light according to the invention has at least one LED 24 for the flashing light which transmits light for the flashing light into a light chamber which is positioned adjacent to the light chamber 11 for the flashing light. In the exemplary embodiment shown in FIG. 1, the LED 24 transmits light for the flashing light into the light chamber 12 for the reversing light, which light chamber 12 is positioned horizontally next to the light chamber 11 for the flashing light, specifically in such a way that the light chamber 12 for the reversing light is positioned further inward with respect to the center of a vehicle than the light chamber 11 for the flashing light. As a result, the flashing light can be perceived with certainty even if the rear light 10 is viewed at a viewing angle of 450 from the inside.

The transmission direction of the, or of each, LED 24 which transmits light for the flashing light into the light chamber 12 which is adjacent to the light chamber 11 for the flashing light is offset by an angle between 30° and 150° with respect to the transmission direction of the other LED 14 for the flashing light. This offset between the, or each, LED 24 which transmits light for the flashing light into the light chamber 12 which is adjacent to the light chamber 11 for the flashing light and the LED 14 which is positioned in the light chamber 11 for the flashing light and transmits light for the flashing light toward the rear is between 45° and 145°, most preferably between 60° and 120°.

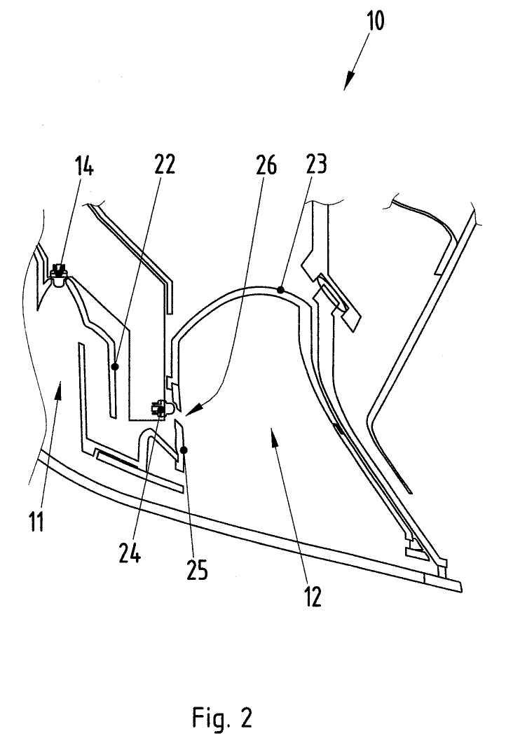

In the exemplary embodiment shown in FIG. 2, the transmission direction of the LED 24 which transmits light for the flashing light into the light chamber 12 for the reversing light, the light chamber 12 being adjacent to the light chamber 11 for the flashing light, is offset by approximately 90° with respect to the transmission direction of the other LED 14 which transmits light for the flashing light toward the rear.

In this context, the LED 24 which transmits its light into the light chamber 12 for the reversing light is positioned behind what is referred to as an additional panel 25 which, together with the wall 23, bounds the light chamber 12 for the reversing light, with the LED 24 transmitting the light for the flashing light into the light chamber 12 for the reversing light through an opening 26 which is integrated into the additional panel 25.

1. A rear light for a motor vehicle, comprising:
a first light chamber;
at least one lighting device for projecting a flashing light, said at least one lighting device including a plurality of LEDs positioned in said first light chamber and transmitting light toward a rear for forming said flashing light;
at least one further lighting device selected from the group consisting of a reversing light, a tail light, a brake light, and a fog light; and
at least one second light chamber adjoining said first light chamber and holding said at least one further lighting device, at least one of said LEDs transmitting light for forming said flashing light projecting into said second light chamber positioned adjacent to said first light chamber.

2. The rear light according to claim 1, wherein said further lighting device is a reversing light disposed in said second light chamber, and said one of said LEDs transmits light for said flashing light into said second light chamber for said reversing light which is positioned adjacent to said first light chamber for said flashing light.

3. The rear light according to claim 2, wherein said second light chamber for said reversing light is positioned to a side of said first light chamber for said flashing light.

4. The rear light according to claim 1, wherein a transmission direction of said one of said LEDs which transmits light for said flashing light into said second light chamber which is adjacent to said first light chamber, is offset by an angle between 30° and 150° with respect to a transmission direction of other ones of said LEDs forming said flashing light.

5. The rear light according claim 1, wherein a transmission direction of said one of said LEDs transmitting light for said flashing light into said second light chamber which is adjacent to said first light chamber is offset by an angle between 45° and 135° with respect to a transmission direction of other ones of said LEDs for said flashing light.

6. The rear light according to claim 1, wherein a transmission direction of said one of said LEDs transmitting light for said flashing light into said second light chamber which is adjacent to said first light chamber is offset by an angle between 60° and 120° with respect to a transmission direction of other ones of said LEDs for said flashing light.

7. The rear light according to claim 1, wherein a transmission direction of said one of said LEDs transmitting light for said flashing light into said second light chamber which is adjacent to said first light chamber is offset by an angle of approximately 90° with respect to a transmission direction of other ones of said LEDs for said flashing light.

8. The rear light according to claim 3, wherein said second light chamber for said reversing light is positioned further inward with respect to a center of a vehicle when compared to said first light chamber for said flashing light.
